(19) United States
(12) Patent Application Publication
(10) Pub. No.: US 2013/0127262 A1
(43) Pub. Date: May 23, 2013

(54) Protective Sensor System for a Hand-Held Power Tool

(71) Applicant: Jochen Roser, Leonberg-Gebersheim (DE)

(72) Inventor: Jochen Roser, Leonberg-Gebersheim (DE)

(73) Assignee: Robert Bosch GmbH, Stuttgart (DE)

(21) Appl. No.: 13/503,232

(22) PCT Filed: Oct. 8, 2010
(86) PCT No.: PCT/EP2010/065120

§ 371 Date: Jul. 4, 2012

(30) Foreign Application Priority Data
Oct. 23, 2009 (DE) 10 2009 045 944.8

(51) Int. Cl. H02H 1/00

(52) U.S. Cl. CPC H02H 1/0007
USPC 307/326

(57) ABSTRACT

The disclosure relates to a hand-held power tool comprising a housing having a handle portion, a tool portion for a tool that can be driven to move linearly and/or oscillate, an operator part on the housing side for the activation of the tool and/or the power tool on the user side, a drive unit for producing a working movement of the tool, an electronic unit for supplying the drive unit at least with open-loop control and/or closed-loop control signals, and an operating voltage unit for making an electrical DC voltage available, the drive unit comprising at least one excitation actuator having a volume of an excitation-active material, which actuator is supplied with power by the operating voltage unit when operated and which is controlled in an open or closed loop control by the electronic unit.

### PRIOR ART

The invention proceeds from a hand-held power tool comprising a housing having a handle region, a tool region for a tool which can be driven in a linear and/or oscillating manner, a housing-mounted operator control part for activation of the tool and/or power tool by a user, a drive unit for generating a working movement of the tool, an electronics unit for supplying at least open-loop and/or closed-loop control signals to the drive unit, an operating voltage unit for providing an electrical DC voltage, with the drive unit comprising at least one excitation actuator having a volume of excitation-active material, which excitation actuator is supplied with electrical power by the operating voltage unit during operation and is subjected to open-loop control or closed-loop control by the electronics unit.

Hand-held power tools are distinguished by the fact that they are portable and are held and controlled by hand by an operator during operation. Said hand-held power tools can be operated in a cable-free manner using battery packs or by mains power. Said hand-held power tools generally comprise just one housing which is completely held by the user. The machine tools which are generally permanently installed and are not held by hand have a suitable enclosure or require two hands to be used for operator control, as a result of which the situation of the operator accidentally touching the active parts, in particular the active tool region, of the ultrasound oscillator can be prevented. The hand-controlled power tools under consideration here can generally be controlled with one hand, and there is therefore a risk of the user touching the tool region, in particular a sonotrode, which is designed in the form of a blade, for example, of an ultrasound-operated machine tool, with his free hand, and there is therefore a considerable risk of injury. Since the abovementioned protective mechanisms cannot be used in hand-controlled ultrasound-operated machine tools of this kind and a user generally guides a workpiece, which is to be processed, with one hand and controls the tool with the other hand, the user may, under unfavorable conditions, for example if said user slips or is accidently pushed, unintentionally touch the active sonotrode, as a result of which the user may be seriously injured.

The prior art discloses methods and apparatuses for identifying unintentional proximity to dangerous tool regions. For example, DE 696 24 124 T2 describes a method and an apparatus for detecting the distance between a first object and a second object, with a proximity signal being exchanged between the first and the second object on a capacitive basis by means of a transceiver system. Protective measures can be initiated even before contact is made. However, a very high level of outlay on circuitry is required.

### DISCLOSURE OF THE INVENTION

The invention proceeds from a hand-held power tool comprising a housing having a handle region, a tool region for a tool which can be driven in a linear and/or oscillating manner, a housing-mounted operator control part for activation of the tool and/or power tool by a user, a drive unit for generating a working movement of the tool, an electronics unit for supplying at least open-loop and/or closed-loop control signals to the drive unit, an operating voltage unit for providing an electrical DC voltage, with the drive unit comprising at least one excitation actuator having a volume of excitation-active material, which excitation actuator is supplied with electrical power by the operating voltage unit during operation and is subjected to open-loop control or closed-loop control by the electronics unit.

It is proposed that a protective sensor unit which a proximity or touch sensor for detecting contact between a body part of a user and the tool region is coupled to the drive unit such that the drive unit is disconnected when said user touches a critical region of the power tool.

In other words, the hand-held power tool comprises a protective sensor unit which ensures that the drive unit is automatically disconnected, and therefore that the user is protected against injury, when a body part, in particular a hand of a user, touches a dangerous region of the power tool, for example a sonotrode of a power ultrasound tool. As a result of this, the potential for injury, in particular when cutting or burning using a hand-controlled ultrasound tool, can be considerably reduced. In principle, a method like that in DE 696 24 124 T2 can be used for evaluation. However, in contrast to the disclosure in DE 696 24 124 T2, contact with the dangerous region, for example the sonotrode, is always identified, this considerably simplifying the evaluation electronics and making them especially suitable for a hand-held power tool.

The protective sensor unit is advantageously arranged in the electronics unit, and the proximity or touch sensor is advantageously arranged in or on the tool region. Therefore, the protective sensor unit can be formed, for example, in a printed circuit board of an electronics unit which is preferably arranged in the housing of the machine tool, it being possible to dispense with additional expenditure on parts and space for a separate printed circuit board for the protective sensor unit. In order to identify contact by the user, the proximity or touch sensor is, in this case, advantageously arranged directly in or on the tool region in order to be able to reliably identify contact by a body part of the user.

The proximity or touch sensor can be designed in any desired manner in principle. In an advantageous refinement, the proximity or touch sensor is designed as a residual current sensor for measuring a residual current between at least one live part of the handle region of the tool and the tool region via the body of the user. Therefore, a live surface, for example one or more touch contacts, can be arranged in the handle region, so that a user who is controlling the machine tool, establishes electrical contact with the live part of the handle region by way of his hand which is controlling the tool. A further electrode or a plurality of electrodes can be provided in the tool region, for example in the form of a metal sonotrode. If a user now touches the sonotrode with his free hand, a small residual current which cannot be felt by the user flows between the handle region, the hand controlling the tool, and the hand which is touching the tool region by means of the body of the user, it being possible for the residual current sensor to identify unintentional contact with the tool region. This provides a simple manner of contact detection which can extremely reliably identify contact with the tool region without extensive outlay on circuitry and can disconnect the drive unit.

According to an advantageous refinement, the proximity or touch sensor can comprise a resonant circuit detuning sensor for measuring detuning of a high-frequency resonant circuit. Therefore, an electrical resonant circuit can be connected, for example, in or on the electrically conductive tool region, for example a metal sonotrode, such that contact with the sonotrode represents an element which influences the frequency of the resonant circuit. When contact is made with the sonotrode, the electrical properties, in particular the capacitance and damping of the resonant circuit, change, and therefore the resonant frequency of the resonant circuit is changed as a result. In this case, different materials exert different influencing factors on the detuning of the resonant circuit because in particular organic materials produce a characteristic change in the resonant circuit frequency. If the tool region is designed as an extremely sensitive element of the resonant circuit, even proximity of a material to the tool region can be detected, so that an resonant circuit detuning sensor can identify the proximity of or contact by organic materials, in particular the hand of a user, with a high degree of accuracy, and can disconnect the drive unit in good time in order to protect the user against injury.

In a further advantageous possible refinement, the proximity or touch sensor comprises a movement sensor. The movement sensor can be designed in such a way that it can identify movement in the physical vicinity of the tool region. To this end, it is advantageous to use a capacitive proximity sensor, as disclosed in DE 696 24 124 T2, for example. In this case, the user again forms part of an electrical circuit and a first electrode forms a capacitance, with the user being connected to a first contact of the protective electronics system by means of a live region of the handle part of the power tool, for example. The second electrode is formed by the tool region itself, which tool region is preferably metal for this purpose. If a body part of the user approaches the tool region, the capacitance, which is formed through these two electrodes, increases, and therefore proximity and, in particular when the capacitance is changing, an approaching movement can be identified, it being possible to disconnect the drive unit, in order to deactivate the tool region, at least when a critical distance is undershot.

In a further advantageous exemplary embodiment, the proximity or touch sensor can be configured as a PIR sensor. A PIR sensor is an electronic sensor which identifies movements in its immediate surroundings and therefore can operate as an electronic movement sensor. In this case, the PIR sensor (PIR =Passive Infrared) reacts, using the pyroelectricity of its receiver surface, to a change in temperature which can be designed, in particular, for the thermal radiation from a human. A PIR sensor reacts only to changing signals and is therefore highly suitable for identifying that a body part of a user has entered the detection region of the sensor.

According to a further advantageous design, the proximity or touch sensor is in the form of an ultrasound sensor. An ultrasound sensor usually comprises a transmitter and receiver and responds to reflections of the emitted ultrasound radiation in the monitoring region, and can therefore identify objects entering the detection region on the basis of a Doppler effect. An ultrasound movement sensor of this kind can be arranged in the tool region in such a way that it is inoperative in the working direction of the power tool but has a high level of detection sensitivity in directions in which the user may accidentally touch the tool region. If unintentional contact is now made with the tool region, the ultrasound movement sensor can identify a movement of this kind in good time and deactivate the drive unit. Therefore, a movement sensor can disconnect the drive unit well before contact is made with the dangerous tool region and ensure preventative protection of the user.

According to an advantageous refinement, the proximity or touch sensor can be connected to the electronics unit for rapid disconnection of the drive unit, in particular for forming an electrical short circuit of the excitation actuator. The excitation actuator generally comprises a piezoelectric or magnetostrictive transducer which comes to a stop in a few milliseconds after the high-frequency oscillation which drives it is disconnected on account of internal damping values. However, mechanical energy can slowly dissipate, in particular due to resonance phenomena in the tool region, in particular in a sonotrode, so that a relatively long lingering process, in which there is a risk of the user being injured, takes place even after the drive unit has been disconnected. In order to shorten the disconnection time, the proximity or touch sensor can be connected to the electronics unit, which generally comprises the protective sensor unit, for rapid disconnection such that the mechanical energy of the tool region is reduced as quickly as possible, in particular due to an electrical short circuit being formed or due to a DC voltage, for example a constant voltage, or an attenuating resistance being connected to the excitation actuator. In a further variant embodiment, the excitation actuator can be anticyclically excited by the actuation electronics system, so that the ultrasound oscillations are actively damped. It goes without saying that the measures can also be provided in combination.

In a further advantageous refinement, the protective sensor unit is designed to disconnect the electrical DC voltage of the operating voltage unit. If the protective sensor unit identifies the proximity to or contact with the tool region, in addition to disconnecting the excitation actuator, the electrical voltage supply, that is to say the DC voltage of the operating voltage unit, can be disconnected in order to deactivate further active parts of the power tool. Particularly in the case of power tools which comprise coupled excitation actuators or both ultrasound excitation actuators and motor-operated actuators, disconnection of the voltage supply results in complete deactivation of the machine tool, so that any mechanically active regions of the machine can be disconnected and therefore injury to the user can be precluded.

According to a further advantageous refinement, the protective sensor unit is designed to lock or deactivate the operator control part when proximity to or contact with the tool region is identified. By virtue of locking or deactivating the operator control part the user is forced to mechanically or electronically unlock the power tool or to reactivate said power tool in some other way in order to thus correct the operating position of said operator control part and a dangerous holding position of the power tool. Therefore, in order to recommission the power tool, provision is made firstly for an acknowledgement signal to have to be output, for example by means of a reset button, and/or for the operator to have to first switch off and then switch on the appliance again, and/or for it to be possible to switch on said appliance again only after a prespecified waiting time or another suitable measure. Appropriate devices can be provided for this purpose.

This also forces the user to consider his behavior in relation to the power tool, as a result of which discipline in respect of using the power tool so as to prevent accidents can be increased.

In an advantageous refinement, the protective sensor unit can be designed to output a visual and/or audible and/or haptic warning signal when a predeterminable distance or contact strength is undershot. Particularly when using a proximity sensor, but also when using a touch sensor, at least one signal in the form of a visual or acoustic warning signal or a haptic warning signal, for example by vibration of the power tool, can alert the user of the fact that he is entering the danger region of the machine, and that automatic disconnection at least of the excitation actuator is imminent, when a predeterminable distance is undershot or when contact is made with a certain contact force, even without disconnection of the excitation actuator or in the event of only slight contact with the tool region. Therefore, particularly when using a proximity sensor, warning signals for warning the user of contact in good time, without the working process having to be interrupted, can already be output when a distance which has not yet been assessed as critical is undershot.

According to an advantageous variant refinement, the protective sensor unit can be designed to disconnect the drive unit when a predeterminable contact strength is undershot. Therefore, the protective sensor unit can be configured such that the excitation actuator is disconnected only when contact is made with the tool region at a critical contact strength of a certain level. Therefore, non-critical distances or only slight contact or brushing of the tool region remain inconsequential; the drive unit is automatically disconnected only when the user is at a proximity to the tool region which can be judged as critical, and therefore the instances of unintentional disconnection can be considerably reduced but operational safety of the user is still ensured.

### DRAWINGS

Further advantages can be gathered from the following description of the drawings. Exemplary embodiments of the invention are illustrated in the drawings. The drawings, the description and the claims contain numerous features in combination. A person skilled in the art will expediently also consider the features on their own and combine them to form meaningful further combinations.

In the drawings:

FIG. 1 shows an exemplary embodiment of a hand-held power tool in a refinement as a cutting appliance with a protective sensor unit;

FIG. 2 shows a further exemplary embodiment of a hand-held power tool with a protective sensor unit in the refinement as a drill;

FIG. 3 shows a basic schematic diagram of an actuation arrangement of an excitation actuator having an AC voltage supply using mains power and a DC voltage supply using a battery pack and also having a protective sensor unit and a proximity or touch sensor;

FIG. 4 shows a basic schematic diagram of a further exemplary embodiment of an actuation arrangement of an excitation actuator having an operating voltage unit, an electronics unit and a protective sensor unit with a proximity or touch sensor;

FIG. 5 schematically shows an exemplary embodiment of a protective sensor unit of a power tool having a residual current sensor;

FIG. 6 schematically shows a further exemplary embodiment of a power tool having a resonant circuit detuning sensor; and

FIG. 7 shows a schematic view of a third exemplary embodiment having a capacitive proximity sensor.

### EMBODIMENTS OF THE INVENTION

In the figures, identical or identically acting components are provided with the same reference symbols.

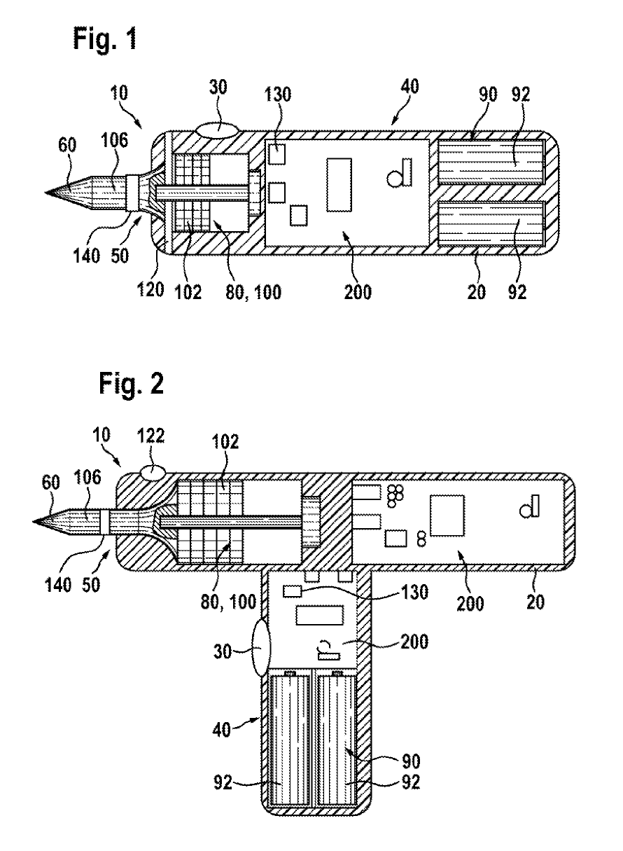

In order to explain the invention, FIGS. 1 and 2 show different examples of hand-held power tools 10. FIG. 1 shows a cutting appliance having an elongate housing form; FIG. 2 shows a drill having a T-shaped housing form.

The hand-held power tool 10 comprises a housing 20 having a handle region 40. An operator holds the power tool 10 on the handle region 40 and can control the power tool 10. The power tool 10 also comprises a tool region 50 for a tool 60, for example a blade (FIG. 1) or a drill (FIG. 2) or another tool corresponding to another type of appliance, which can be driven in a linear and/or oscillating manner. A housing-mounted operator control part 30 can be used for activation of the tool 60 and/or the power tool 10 by a user.

A drive unit 80 is arranged in the housing 20, said drive unit comprising only one drive component, which is formed by an excitation actuator 100, in the examples according to FIG. 1 and FIG. 2. Said excitation actuator can be in the form of a piezo-excited Langevin oscillator (also called piezoactuator) which comprises a volume of piezoelectrically active material 102, for example piezoceramic disks which are compressed and which change in length when an electrical voltage is applied. When a high-frequency electrical voltage is applied, ultrasound is generated in a manner which is known per se, said ultrasound being conducted to a tool 60 via a coupling element 106. The coupling element 106 can be a sonotrode which is known per se.

An electronics unit 200 which is arranged in the housing 20 is used to supply at least open-loop and/or closed-loop control signals to the drive unit 80, and to supply voltage to the excitation actuator 100. An operating voltage unit 90, in this case a battery or rechargeable battery pack containing batteries or rechargeable batteries 92 is used to provide an electrical DC voltage for the electronics unit 200 which converts the operating voltage into a high-frequency voltage signal with which the excitation actuator 100 is excited in the desired manner to oscillate. The electronics unit 200 can be arranged on one printed circuit board (FIG. 1) or a plurality of printed circuit boards (FIG. 2). Activation of the tool 60 by the activation actuator 30 can be indicated by a signaling means 122 (FIG. 2).

In the power tools 10 according to FIGS. 1 and 2, a proximity or touch sensor 140 is arranged in the coupling element 106 of the tool region 50, said proximity or touch sensor—not illustrated—being connected to the sensor unit 130 which is arranged in the electronics unit 200. If the proximity or touch sensor 140 perceives contact, for example by a hand of a user, this information is forwarded to the sensor unit 130 which can automatically deactivate the piezoelectrically active material 102 of the excitation actuator 100 of the drive unit 80 or deactivates the operating voltage supply to the power tool 10, so that not only can the drive unit 80 and the excitation actuator 100 be deactivated but further electrical parts of the power tool, such as open-loop and closed-loop control units of the electronics unit 200, can likewise be disconnected. If the proximity or touch sensor 140 identifies removal of the user's hand, it sends a corresponding signal to the protective sensor unit 130 in order to initiate reactivation of the drive unit 80 and of the operating voltage unit.

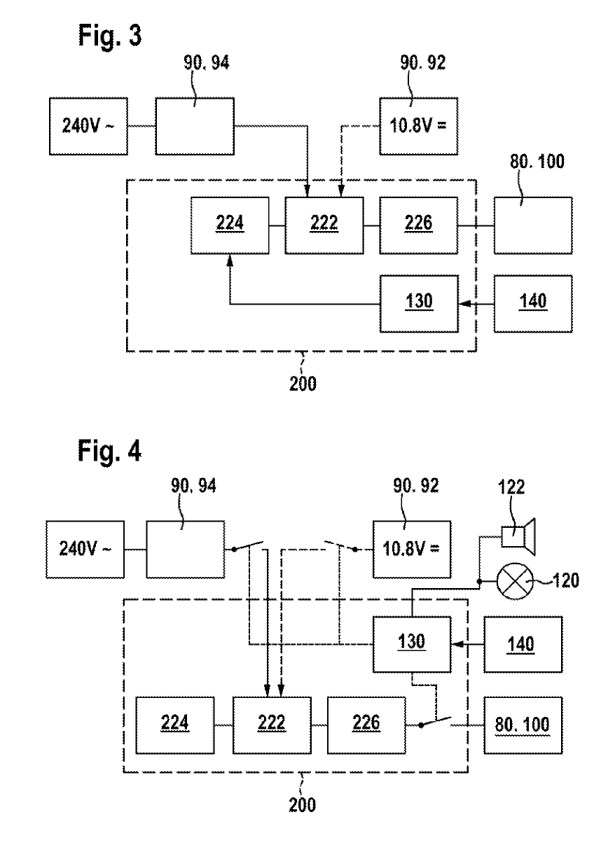

FIG. 3 schematically shows an electrical connection between the main electrical constituent parts of the power tool. To this end, the power tool comprises an excitation actuator 100, for example in the form of a piezoactuator in the drive unit 80 which can be operated with an AC voltage supply 94 from a power supply system or a DC voltage supply 92 by a battery pack. When mains power is supplied to the electronics unit 200, for example at an AC voltage of 230 volts, an assembly 94 which rectifies and smoothes the AC voltage is provided. The electronics unit 200 comprises a power generation unit 222 into which the DC voltage is fed, and which is coupled to the excitation actuator 100 by means of a corresponding filter device 226. A closed-loop control unit 224 provides the closed-loop control signals for the excitation actuator 100. A proximity or touch sensor 140 which can detect contact between a body part of a user and the tool region 50, in particular the sonotrode, is arranged in the physical vicinity of the tool region, in particular in the vicinity of the drive unit 100. Said proximity or touch sensor forwards its signals to a protective sensor unit 130 which is contained in the electronics unit 200. If inadvertent proximity to or contact with the tool region is identified by the proximity or touch sensor 140, the protective sensor unit 130 outputs a signal to the closed-loop control unit 224, as a result of which the power generation unit 222 is disconnected. Therefore, the drive unit 80 is turned off and the power tool is deactivated, so that there can be no further danger to the user.

FIG. 4 shows a further variant of the connection principle of FIG. 3. In this case, the protective sensor unit 130 is connected to two further protective sensor switch-off elements which can disconnect the operating voltage units 90, 94 for mains voltage operation or 90, 92 for battery operation of the electronics unit 200 in the event of the tool region being approached or touched. In another variant embodiment, the power supply can also be disconnected by the protective sensor unit 130 directly at the excitation actuator 100. Furthermore, the protective sensor unit 130 is connected to an audible and/or visual signal warning transmitter 122, 120 in order to output an audible and/or visual signal if the tool region is approached or if the tool region is touched, in order to warn the user that the power tool will soon be automatically disconnected.

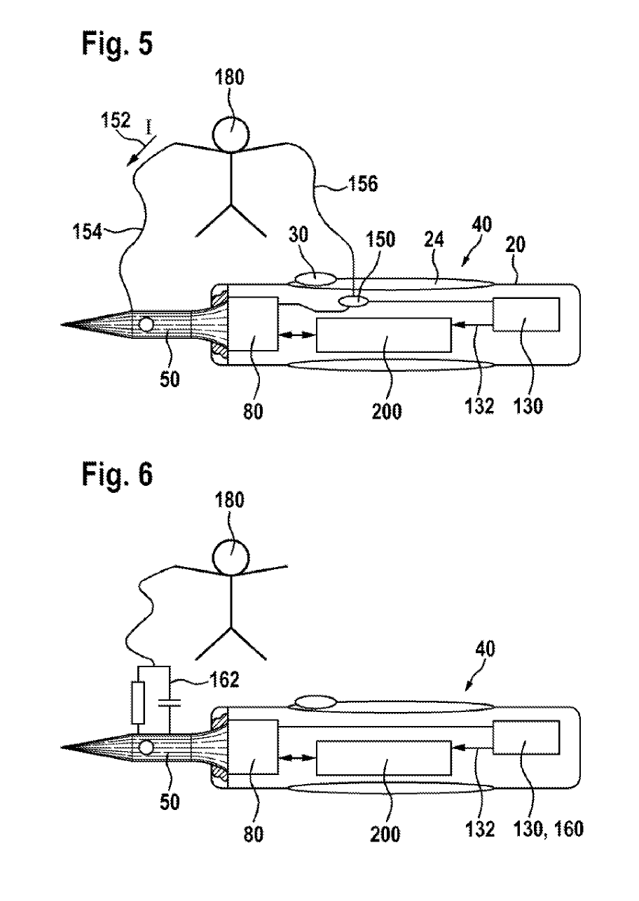

FIG. 5 shows an exemplary embodiment of a hand-held power tool which comprises a fault current sensor 150 for generating a voltage potential and for measuring a fault current flowing through said fault current sensor between at least one live part of the handle region 40 of a housing 20 and the tool region 50 by means of the body of the user 180. To this end, a protective sensor unit 130 is accommodated in the housing 20 of the power tool 10, said protective sensor unit being connected to the electronics unit 200 by means of a disconnection signal line 132, said electronics unit being electrically coupled to the drive unit 80 in order to excite high-frequency ultrasound oscillations. A fault current sensor 150 is also arranged in the housing 20, the first electrode of said fault current sensor being connected to a conductive part of the handle housing 24 which is located in the immediate vicinity of the operator control part 30, so that the user 180 always establishes an electrical contact between the handle region 24 and his body when he operates the power tool 10. This electrical connection is represented as a fault current contact 156 by means of which the user 180 is electrically connected to the first contact of the fault current sensor 150. If the user 180 now touches the tool region 50, for example by way of his free hand, a current 152 flows via this second fault current line 154 on account of the voltage potential impressed by the fault current sensor 150, so that the fault current sensor 150 registers a fault current which flows across the body of the user 180. In this case, the protective sensor unit 130 deactivates the drive unit 80 by means of the disconnection signal line 132 and the electronics unit 200, so that the mechanical power output by the tool region 50 is interrupted. It is important here for the contact point in the handle region 40 to be arranged such that, during proper operator control of the hand tool, the user 180 always has to be in contact with said contact point in order to guarantee correct functioning of the protective circuit. This can be ensured, for example, by arranging the contact-making means 156 directly at or on the operator control element 30 of the power tool 10. In the normal case the contact does not have any influence on the user 180, no current flows since the electrical circuit is not closed. If the user 180 touches the metal sonotrode 50, a live contact 154 is created, so that the electrical circuit is closed and a small current 152 which is not dangerous to and cannot be perceived by the user 180 begins to flow. This fault current flow can be registered by the evaluation electronics system of the protective sensor unit 130 directly or by means of the current sensor 150, said evaluation electronics system disconnecting the ultrasound generator drive unit 80 by means of the disconnection signal line 132 starting from a threshold value of, for example, 100A.

In a further embodiment according to FIG. 6, electrical contact points in the handle region can be dispensed with since a frequency-sensitive evaluation method is used. In this case, the metal sonotrode body of the tool region 50 is impressed with a high-frequency AC voltage, which is not dangerous to the user 180, by means of an electronic resonant circuit which is contained in the protective sensor unit 130. When the user 180 touches the sonotrode 50, said user introduces a parasitic capacitance and possibly damping 162 into the sensor system resonant circuit, as a result of which the resonant frequency of the impressed oscillation changes and said oscillation is possibly damped. This change can be identified by the resonant circuit detuning sensor 160, with the ultrasound drive unit 80 likewise being disconnected via the disconnection signal line 132 and the electronics unit 200. Depending on the type of change in the oscillation, human tissue can be distinguished from other materials, for example metal or wood, in order to achieve a reliable response of the safety circuit.

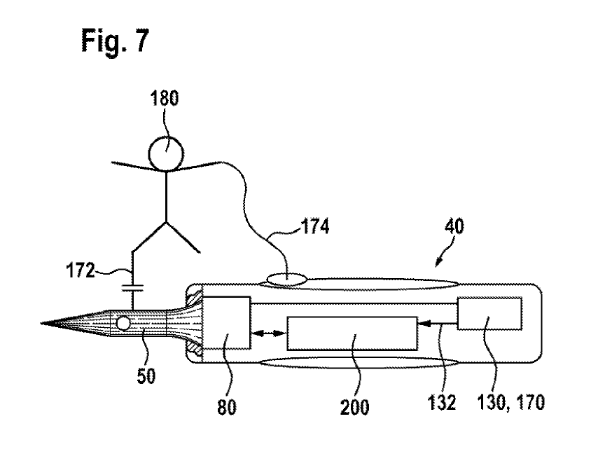

Finally, FIG. 7 schematically shows a further exemplary embodiment of a power tool 10 having a protective sensor unit. A method similar to that of DE 696 24 124 T2, for example, for a capacitive proximity sensor control operation on the basis of a capacitive distance measurement can be used in this case. In contrast to the use which is described in DE 696 24 124 T2, the capacitive proximity sensor is based on the principle that contact with the dangerous component—in this case the active sonotrode—is first identified. Therefore, a considerably more simple evaluation electronics system can be used. To this end, the power tool 10 comprises a movement sensor 170 based on a capacitive touch sensor 172. Analogously to in the case of the fault current-based protective sensor unit, the user 180 is connected to an electrode of the movement sensor 170 by his hand which is controlling the tool by means of a capacitive sensor line 174. If the user 180 touches the tool region 50, and therefore the metal sonotrode, by way of a body part, the capacitive touch sensor 172 identifies a change in the capacitance, as a result of which the conclusion is drawn that the user 180 is in contact, and therefore the protective sensor unit 130 deactivates the drive un it 180 and switches off the sonotrode by means of the disconnection signal line 132 when there is a considerable change in the capacitance of the capacitive touch sensor 172, in order to protect the user 180 against injury.

Disconnection of the excitation actuator of an ultrasound tool is sufficient since the sonotrode is guaranteed to stop very quickly within a few milliseconds after the generator is disconnected, without further measures. In contrast to other tools with large rotating masses, very little kinetic energy can be dissipated in the case of an ultrasound oscillator, and therefore the mechanical output power is dissipated very quickly after disconnection of the excitation means on account of internal damping.

1. A hand-held power tool comprising:
a housing having a handle region;
a tool region for a tool which can be driven in a linear and/or oscillating manner;
a housing-mounted operator control part for activation of the tool and/or power tool by a user;
a drive unit for generating a working movement of the tool;
an electronics unit for supplying at least open-loop and/or closed-loop control signals to the drive unit; and
an operating voltage unit for providing an electrical DC voltage,
wherein the drive unit includes at least one excitation actuator, in particular an ultrasound actuator, having a volume of excitation-active material,
wherein the excitation actuator (i) is supplied with electrical power by the operating voltage unit during operation, and (ii) is subjected to open-loop control or closed-loop control by the electronics unit, and
wherein a protective sensor unit, including a proximity or touch sensor for detecting contact between a body part of a user and the tool region, is coupled to the drive unit such that the drive unit is disconnected when said user is unintentionally in proximity to or in contact with said tool region.

2. The hand-held power tool as claimed in claim 1, wherein:
the protective sensor unit is arranged in the electronics unit, and
the proximity or touch sensor is arranged in or on the tool region.

3. The hand-held power tool as claimed in claim 1, wherein the proximity or touch sensor includes a residual current sensor for measuring a residual current between at least one live part of the handle region and the tool region via the body of the user.

4. The hand-held power tool as claimed in claim 1, wherein the proximity or touch sensor includes a resonant circuit detuning sensor for measuring detuning of a high-frequency resonant circuit.

5. The hand-held power tool as claimed in claim 1, wherein the proximity or touch sensor includes a movement sensor.

6. The hand-held power tool as claimed in claim 5, wherein the movement sensor is a capacitive touch sensor, a PIR sensor or an ultrasound sensor.

7. The hand-held power tool as claimed in claim 1, wherein the proximity or touch sensor is connected to the electronics unit for rapid disconnection of the drive unit.

8. The hand-held power tool as claimed in claim 7, wherein, for rapid disconnection of the drive unit, provision is made for
forming an electrical short circuit of the excitation actuator,
connecting a DC voltage,
connecting an attenuating resistance, and/or
anticyclic excitation for actively damping the excitation actuator.

9. The hand-held power tool as claimed in claim 1, wherein the proximity or touch sensor is designed to disconnect the electrical DC voltage of the operating voltage unit.

10. The hand-held power tool as claimed in claim 1, wherein the proximity or touch sensor is designed to lock or deactivate the operator control part.

11. The hand-held power tool as claimed in claim 10, wherein, after the operator control part is deactivated, recommissioning can be implemented by
activating an acknowledgement signal,
switching off and switching on the power tool, and/or
switching on said power tool again after a prespecified waiting time.

12. The hand-held power tool as claimed in claim 1, wherein the protective sensor unit is designed to output a visual and/or audible and/or haptic warning signal when a predeterminable distance or contact strength is undershot, and/or to disconnect the drive unit when a predeterminable distance or contact strength is undershot.
